(19) United States
(12) Patent Application Publication
(10) Pub. No.: US 2015/0215465 A1
(43) Pub. Date: Jul. 30, 2015

(54) COMMUNICATION MESSAGE MANAGEMENT METHOD AND ELECTRONIC DEVICE SUPPORTING THE SAME

(71) Applicant: Samsung Electronics Co., Ltd., Suwon-si (KR)

(72) Inventor: Gwang Hui LEE, Gumi-si (KR)

(21) Appl. No.: 14/603,617

(22) Filed: Jan. 23, 2015

(30) Foreign Application Priority Data
Jan. 28, 2014 (KR) 10-2014-0010243

(51) Int. Cl. H04M 3/54; H04W 4/00

(52) U.S. Cl. CPC H04M 3/54; H04W 4/008; H04W 4/16

(57) ABSTRACT

A main electronic device is provided. The main electronic device includes a first main communication module configured to receive a communication message and a main control module configured to forward the communication message to a sub electronic device in correspondence to at least one of a type of the communication message, a type of an application in execution, and a sleep state.

### CROSS-REFERENCE TO RELATED APPLICATION(S)

This application claims the benefit under 35 U.S.C. §119(a) of a Korean patent application filed on Jan. 28, 2014 in the Korean Intellectual Property Office and assigned Serial number 10-2014-0010243, the entire disclosure of which is hereby incorporated by reference.

### TECHNICAL FIELD

The present disclosure relates to a communication message management.

### BACKGROUND

With the recent development of digital technology, electronic devices available for communication and personal information processing while users of the electronic devices are mobile come in many forms, for example, mobile communication terminals, personal digital assistants (PDAs), electronic organizers, smartphones, and tablet personal computers (PCs). Such electronic devices do not stay in their typical original areas and reach mobile convergence stages covering other terminals' areas.

Typically, electronic devices may include a call function such as a voice call and a video call, a message transmission function, such as Short Message Service (SMS)/Multimedia Messaging Service (MMS) and an E-mail function, an organizer function, a capturing function, a broadcast playback function, a video playback function, a music playback function, an Internet access function, an instant messaging function, and a social networking service (SNS) function.

Since electronic devices of the related art are used as separate devices, it is difficult to share information relating to a specific device with other devices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a communication message management method and an electronic device supporting the same.

In accordance with an aspect of the present disclosure, a main electronic device is provided. The main electronic device includes a first main communication module configured to receive a communication message and a main control module configured to forward (or transmit) the communication message to a sub electronic device in correspondence to at least one of a type of the communication message, a type of an application in execution, and a sleep state.

In accordance with another aspect of the present disclosure, a sub electronic device is provided. The sub electronic device includes a first sub communication module configured to receive a forwarded communication message through a network communication network or a second sub communication module configured to receive the forwarded communication message through a short range communication channel, a sub control module configured to control the communication message reception through at least one of the first sub communication module and the second sub communication module, and a sub display module configured to output the received communication message.

In accordance with another aspect of the present disclosure, a communication message management method is provided. The communication message management method includes receiving, by at least one main electronic device, a communication message from another electronic device and forwarding, by the at least one main electronic device, the communication message to a sub electronic device in correspondence to at least one of a type of the communication message, a type of an application in execution, and a sleep state.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic view illustrating a communication message management system according to an embodiment of the present disclosure;

FIG. 2 is a view illustrating a main electronic device according to an embodiment of the present disclosure;

FIG. 3 is a view illustrating a sub electronic device according to an embodiment of the present disclosure;

FIG. 4 is a view illustrating a management method of a main electronic device relating to a communication message management according to an embodiment of the present disclosure;

FIG. 5 is a view illustrating a management method of a sub electronic device relating to a communication message management according to an embodiment of the present disclosure; and

FIG. 6 is a view illustrating a screen interface of a sub electronic device relating to a communication message reception according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description below, a main electronic device may include all information communication devices supporting functions described in an embodiment of the present disclosure, multimedia devices, and all devices using Application Processors (APs), Graphic Processing Units (GPUs), and Central Processing Units (CPUs), for example, application devices thereto. For example, the main electronic device may include devices, such as tablet Personal Computers (PCs), Smart Phones, digital cameras, Portable Multimedia Players (PMPs), Media Players, portable game consoles, and Personal Digital Assistants (PDAs) in addition to mobile communication terminals operating based on communication protocols corresponding to various communication systems.

A main sub device or a sub electronic device described in an embodiment of the present disclosure may be at least one of various forms of wearable electronic devices communicable with a main electronic device, for example, electronic watches, electronic bracelets, electronic anklets, electronic necklaces, electronic earrings, electronic rings, and electronic belts. According to another embodiment of the present disclosure, a sub electronic device may be at least a portion form of suits or pants. The above-mentioned sub electronic device is not limited to a specific form or arrangement position. Moreover, according to another embodiment of the present disclosure, a sub electronic device may be a portable terminal or a smartphone similar to a main electronic device. Accordingly, a sub electronic device described below is not limited to a wearable electronic device or a specific form of an electronic device and may be understood as a form including a network communication module communicable with a main electronic device after accessing a network. According to an embodiment of the present disclosure, a sub electronic device may further additionally include at least part of various components included in a main electronic device, for example.

According to an embodiment of the present disclosure, a communication message management system, each component included in a corresponding system, a system management method, and a management method of each component are described with reference to the accompanying drawings. A system device and a management method according to an embodiment of the present disclosure are not limited to contents described below and thus are applicable to other modified embodiments based on the various embodiments below.

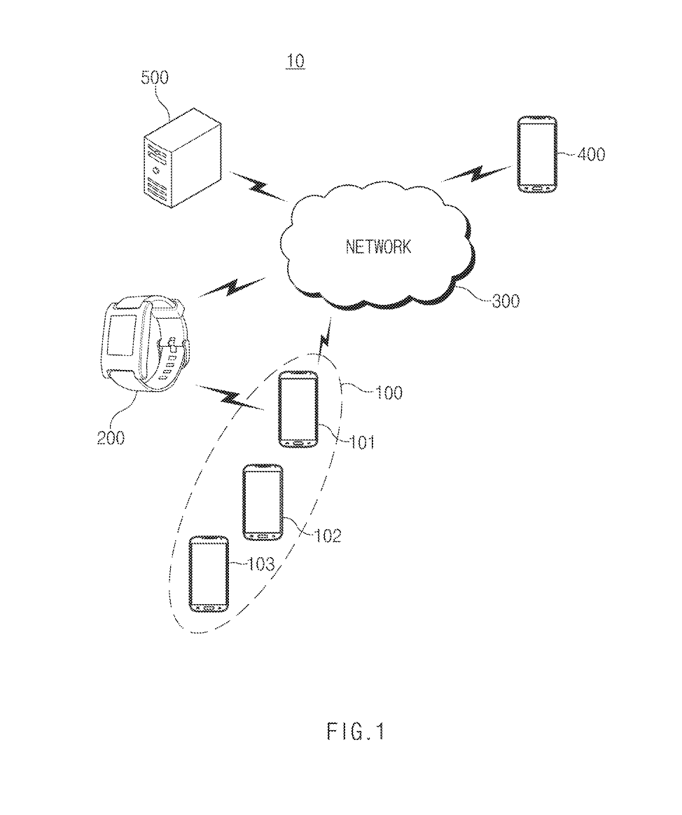

FIG. 1 is a schematic view illustrating a communication message management system according to an embodiment of the present disclosure.

Referring to FIG. 1, a communication message management system 10 may include a main electronic device 100, a sub electronic device 200, and a network 300. Additionally, the communication message management system may further include a message forwarding device 500 connected to a network 300.

In the communication message management system 10, at least one of the main electronic device 100 may establish a short range communication channel with the sub electronic device 200 and also may forward (or relay) a communication message forwarded from another electronic device 400 or the message forwarding device 500 to another electronic device (e.g., the sub electronic device 200). According to an embodiment of the present disclosure, when the main electronic device 100 forms a short range communication channel with the sub electronic device 200 and is in a specific function execution state, for example, a sleep mode state, a sound playback state, a video playback state, or a broadcast reception function execution state, the main electronic device 100 may forward a received communication message to the sub electronic device 200 automatically. Additionally, the main electronic device 100 may forward a received communication message to the sub electronic device 200 when there is a communication message auto forwarding setting or an input event for requesting communication message forwarding occurs. In this process, when a short range communication channel is released, the main electronic device 100 may access a network 300 and perform received communication message forwarding. According to various embodiments of the present disclosure, the main electronic device 100 may include a plurality of electronic devices 101, 102, and 103 as shown in the drawings. The plurality of electronic devices 101, 102, and 103 may include various electronic devices, for example, smartphones, wearable devices, slate PCs, and notebooks. The plurality of electronic devices 101, 102, and 103 may have a setting or receive an input event to forward a communication message to the sub electronic device 200. Accordingly, the sub electronic device 200 may receive the communication message that the plurality of electronic devices 101, 102, and 103 forward and may then classify and output the communication message for each electronic device. The electronic devices 101, 102, and 103 not forming a short range communication channel with the sub electronic device 200 may deliver a communication message that the other electronic device 400 transmits to the message forwarding device 500 through the network 300.

The main electronic device 100 may manage a communication service through the network 300. For example, the main electronic device 100 may form a communication channel with the other electronic device 400 through the network 300. According to an embodiment of the present disclosure, the main electronic device 100 may manage a communication service with the sub electronic device 200 through a short range communication channel. Additionally, the main electronic device 100 may forward a communication message to the sub electronic device 200 through the network 300. The main electronic device 100 may receive a communication connection request message from the other electronic device 400 through the network 300. The main electronic device 100 may forward a corresponding communication message to the sub electronic device 200 in correspondence to a setting or the type of an application in execution.

According to an embodiment of the present disclosure, the first electronic device 101 in the main electronic device 100 may establish a short range a communication channel with the sub electronic device 200. The first electronic device 101 may forward a communication message that the other electronic device 400 transmits to the sub electronic device 200 through a short range communication channel. According to an embodiment of the present disclosure, the second electronic device 102 and the third electronic device 103 in the main electronic device 100 may include ability to establish a short range a communication channel with the sub electronic device 200. However, there is a case that a short range communication channel cannot be established in a current state. In this case, according to an embodiment of the present disclosure, the second electronic device 102 and the third electronic device 103 in the main electronic device 102 may establish a long range communication channel through the sub electronic device 200 and the network 300. The second electronic device 102 and the third electronic device 103 may transmit a communication message that the other electronic device 400 transmits to the sub electronic device 200. Herein, the main electronic device 100, as an electronic device forwarding a communication message (e.g., a communication connection request message, a text message, a multimedia message, an e-mail, and a chatting message) to the sub electronic device 200, is not limited to a specific form or shape. For example, as mentioned above, the main electronic device 100 may be a wearable electronic device that is another type of the sub electronic device 200. For example, the main electronic device 100 may be various electronic devices such as notebook PCs, slate PCs, note PCs, large screen portable electronic devices, smartphones, or body-mounted or wearable electronic devices.

The sub electronic device 200 may be a device communicable with the main electronic device 100 through a short range communication channel or the network 300. The sub electronic device 200 may be manufactured in a wearable form. For example, as mentioned above, the sub electronic device 200 may be prepared in a ring, bracelet, or watch form to be worn on a user's hand portion. The sub electronic device 200 may be manufactured in various forms such as a grip available form or a carrying available form. In the description below, a wearable electronic device is described as one example of the sub electronic device 200. However, as mentioned above, various embodiments of the present disclosure are not limited to the form, appearance, or specific function of the sub electronic device 200.

The sub electronic device 200 may include a power supply, such as a battery. The sub electronic device 200 may support initialization and communication service management based on the power. During communication service management support, the sub electronic device 200 may receive a communication message from the main electronic device 100 through a short range communication channel. Additionally, the sub electronic device 200 may receive a communication message from the main electronic device 100 through the network 300.

The sub electronic device 200 may include various components (or elements) relating to communication service use. For example, the sub electronic device 200 may output an audio signal or display a message after image processing in correspondence to a communication message delivered by the main electronic device 100. Additionally, the sub electronic device 200 may include a vibration module. On the receipt of a communication message forwarded from the main electronic device 100, according to this, the sub electronic device 200 may output a vibration alarm in correspondence to a setting in addition to an audio alarm and a lamp alarm.

When a short range communication channel with the main electronic device 100 is released, the sub electronic device 200 may receive a communication message forwarded through the network 300. While receiving a communication message forwarded through this process (e.g., the network 300), the sub electronic device 200 may establish a short range communication channel with at least one of the other electronic devices and may receive a communication message forwarded through a short range communication channel. After outputting the forwarded communication message, the sub electronic device 200 may establish a communication channel with the other electronic device 400 based on the network 300 in correspondence to a user control.

The message forwarding device 500 may be connected to the network 300. The message forwarding device 500 may support communication service management of the main electronic device 100 connected to the network 300. For example, the message forwarding device 500 may collect communication messages forwarded from the main electronic device 100 through the network 300. The message forwarding device 500 may receive a forwarded communication message including information of the other electronic device 400 relating to a forwarded communication message, information of the main electronic device 100 transmitting a forwarded communication message, a communication message reception time, and forwarded communication message content information, from the main electronic device 100. The message forwarding device 500 may transmit a received communication message to the sub electronic device 200.

According to various embodiments of the present disclosure, the message forwarding device 500 may apply transmission periods differently in correspondence to the type of a received communication message. According to an embodiment of the present disclosure, the message forwarding device 500 may transmit a forwarded communication message to the sub electronic device in real time when the forwarded communication message is a communication message requiring real time processing, for example, a connection request message or an emergency confirmation request message. The message forwarding device 500 may transmit a forwarded communication message to the sub electronic device at specified time intervals when the forwarded communication message is a communication message not requiring real time processing, for example, text message, chatting message, or e-mail. Alternatively, when forwarded communication messages of more than a specified number are accumulated, the message forwarding device 500 may transmit a forwarded communication message to the sub electronic device 200. Alternatively, the message forwarding device 500 may transmit a forwarded communication message to the sub electronic device 200 in correspondence to a network connection available schedule of the sub electronic device 200.

In relation to the message forwarding support, the message forwarding device 500 may include a device network communication module connecting to the network 300, a device memory storing a forwarded communication message, and a device control module controlling forwarded communication collection and transmission. The device memory may store policy information. The device control module may transmit a forwarded communication message in real time or at specified periods in correspondence to the policy information or may transmit a forwarded communication message according to the accumulated amount. Alternatively, the device control module may receive network connection available schedule information of the sub electronic device 200 from the sub electronic device 200 and may transmit a forwarded communication message at the time written in a corresponding schedule.

The network 300 may support a communication service function of the main electronic device 100. For example, the network 300 may include a base station supporting a mobile communication function, a base station controller, and a switching center. The network 300 may support at least one communication method of various generation communication methods such as Second Generation (2G), Third Generation (3G), Fourth Generation (4G), and Fifth Generation (5G). According to an embodiment of the present disclosure, on the receipt of a voice call service connection message from the other electronic device 400, the network 300 may deliver this to the main electronic device 100. On the receipt of a message forwarding request of the main electronic device 100, the network 300 may deliver a forwarded communication message to the sub electronic device 200. Alternatively, the network 300 may deliver a forwarded communication message to the message forwarding device 500 or may deliver a forwarded communication message to the sub electronic device 200 in correspondence to a request of the message forwarding device 500. Upon the receipt of a voice call connection confirmation message, the network 300 may establish a voice call channel between the other electronic device 400 and the sub electronic device 200.

According to another embodiment of the present disclosure, on the receipt of a video call service connection message from the other electronic device 400, the network 300 may deliver the video call service connection message to the main electronic device 100. On the receipt of forwarding on a video call connection request message of the main electronic device 100, the network 300 may deliver the message to the sub electronic device 200 or through the message forwarding device 500. The network 300 may establish a video call channel between the other electronic device 400 and the sub electronic device 200. According to another embodiment of the present disclosure, the network 300 may support a message forwarding service of the main electronic device 100. For example, the network 300 may deliver text, voice, video message, chatting message, or e-mail transmitted from the other electronic device 400 to the main electronic device 100 and may then forward the text, the voice, the video message, the chatting message, or the e-mail to the sub electronic device 200 in response to a forwarding request.

According to an embodiment of the present disclosure, the network 300 may support a communication based on an Internet Protocol (IP) address. According to an embodiment of the present disclosure, the network 300 may include a network device supporting a Wi-Fi communication method, for example, a wireless access point, a controller controlling the wireless access point, and a core network connected to the controller. The network 300 may establish a communication channel between the other electronic device 400 and the main electronic device 100, a communication channel between the main electronic device 100 and the sub electronic device 200, a communication channel between the main electronic device 100 and the message forwarding device 500, and a communication channel between the message forwarding device 500 and the sub electronic device 200. The network 300 may support forwarding a communication message of the other electronic device 400 to the sub electronic device 200 based on the communication channel.

The other electronic device 400 may manage a communication service with the main electronic device 100 through the network 300. The other electronic device 400 may include a communication module available for the access of the network 300. For example, the other electronic device 400 may be a mobile communication terminal. The other electronic device 400 may transmit a communication service connection message to the main electronic device 100 through the network 300. The other electronic device 400 may establish a communication channel with the sub electronic device 200 in correspondence to the message forwarding of the main electronic device 100.

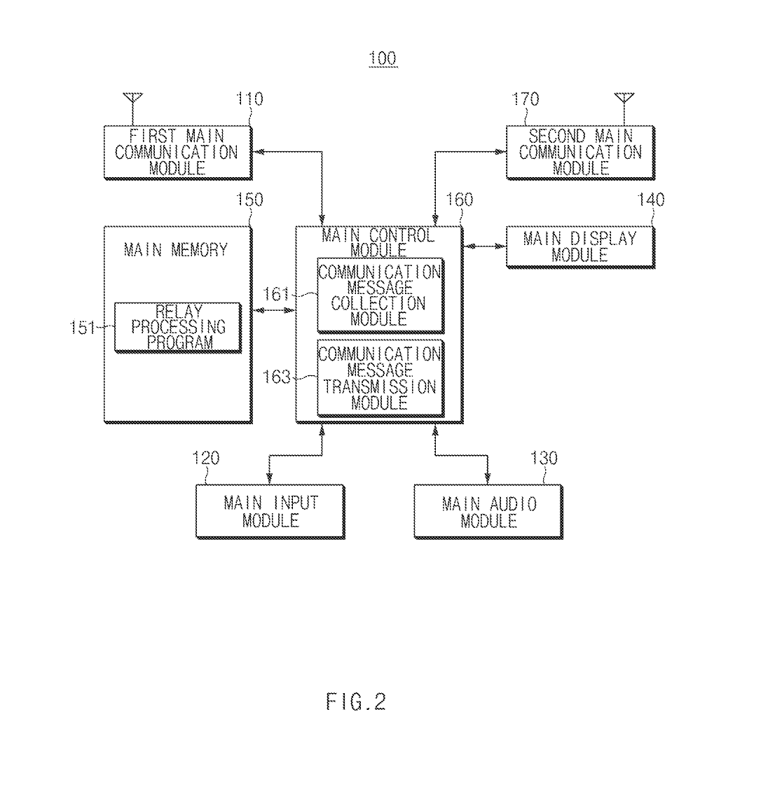

FIG. 2 is a view illustrating a main electronic device according to an embodiment of the present disclosure.

Referring to FIG. 2, a main electronic device 100 may include a first main communication module 110, a main input module 120, a main audio module 130, a main display module 140, a main memory 150, a main control module 160, and a second main communication module 170, but is not limited thereto. Additionally, the main electronic device 100 may further include a camera module to support video call service.

The main electronic device 100 may establish a short range communication channel with the sub electronic device 200 through the second main communication module 170. When a short range communication channel is established or a specific application is in execution, the main electronic device 100 may transmit a communication message that the other electronic device 400 transmits to the sub electronic device 200 through a short range communication channel. When a short range communication channel is not established with the sub electronic device 200 or a specific application is in execution, the main electronic device 100 may forward a communication message received from the other electronic device 400 to the sub electronic device 200 through the network 300.

The first main communication module 110 may establish a communication channel with the network 300. The first main communication module 110 may be a module communicable with the network 300, for example, a mobile communication module. Additionally, the first main communication module 110 may be a communication module using Public Switched Telephone Network (PSTN) in correspondence to the characteristics of the network 300. The first main communication module 110 may maintain a camping state after accessing a base station. The first main communication module 110 may establish a communication channel with the other electronic device 400 through a base station and may receive a communication message including call message, text message, multimedia message, chatting message, and e-mail based on the established communication channel. The first main communication module 110 may forward the received communication message to the sub electronic device 200 through the network 300 in correspondence to a control of the main control module 160.

The main input module 120 may generate an input signal of the main electronic device 100. The main input module 120 may include at least one of a keypad (not shown), a dome switch (not shown), a touch pad (resistive/capacitive) (not shown), a jog wheel (not shown), and a jog switch (not shown). The main input module 120 may be implemented in a button form at the outside of the main electronic device 100 and some buttons may be implemented with touch panels.

According to an embodiment of the present disclosure, the main input module 120 may include a plurality of keys (not shown) for receiving number and text information and setting various functions. Such keys may include a menu import key, a screen on/off key, a power on/off key, and a volume adjustment key. The main input module 120 may generate a key event relating to a user setting and a function control of the main electronic device 100 to deliver the key to the main control module 160. The key event may include a power on/off event, a volume adjustment event, and a screen on/off event. Moreover, a physical key of the main input module 120 may be referred to as a hard key and a virtual key displayed on the main display module 140 may be referred to as a soft key. The main input module 120 may generate an input event relating to a communication message forwarding setting, an input event relating to a communication message forwarding request, and an input event relating to a communication message forwarding release. The input event relating to a communication message forwarding setting may generate an input event determining whether to perform communication message auto forwarding, an application designation event to be applied by communication message auto forwarding, and a state designation event to be applied by communication message auto forwarding.

The main audio module 130 may process an audio signal of the main electronic device 100. For example, the main audio module 130 may transmit an audio signal inputted from the main control module 160 to a speaker. The main audio module 130 may convert voice/sound data into audible sound and output the voice/sound data through a speaker according to a control of the main control module 160. The main audio module 130 may perform a function for delivering an audio signal such as voice inputted from a microphone to the main control module 160. The main audio module 130 may convert an audio signal such as voice received from a mic (not shown) into a digital signal and may then deliver the digital signal to the main control module 160. According to an embodiment of the present disclosure, the main audio module 130 may output guiding sounds and sound effects relating to message auto forwarding setting and guiding sounds and sound effects relating to communication message reception and auto forwarding execution.

The main display module 140 displays (outputs) information processed in the main electronic device 100. For example, when the main electronic device 100 is in a call mode, the main electronic device 100 displays a call related user interface (UI) or a graphic UI (GUI). Additionally, when the main electronic device 100 is in a video call mode or a capturing mode, the main display module 140 displays a captured or/and received image, a UI, or a GUI. The main display module 140 displays an execution screen on various functions (or applications) executed in the main electronic device 100. Then, the main display module 140 activates and displays a virtual input device (e.g., a virtual touch pad) in the execution screen according to a control of the main control module 160 and then delivers a signal inputted through the virtual input device to the main control module 160.

According to an embodiment of the present disclosure, the main display module 140 may output a screen relating to communication message auto forwarding. For example, the main display module 140 may output a screen for receiving a communication message from the other electronic device 400 and a screen for forwarding a received communication message to the sub electronic device 200. According to another embodiment of the present disclosure, the main display module 140 may maintain a previous state without performing additional information output or screen switching when performing communication message auto forwarding. For example, the main display module 140 may maintain a turn-off state or a specific function state.

The main display module 140 may provide a setting screen relating to communication message auto forwarding setting. For example, the main display module 140 may output a screen for selecting communication message auto forwarding execution or release, a screen for inputting information of the sub electronic device 200 for communication message auto forwarding, a screen relating to a device state relating to a communication message auto forwarding time or an application execution state designation.

The main display module 140 may support a screen display by horizontal mode, a screen display by vertical mode, a screen switching display by a change between the horizontal mode and the vertical mode, according to a rotation direction (or, a lying direction) of the main electronic device 100. The main display module 140 may include at least one of a Liquid Crystal Display (LCD), a Thin Film Transistor LCD (TFT LCD), a Light Emitting Diode (LED), an Organic LED (OLED), an Active Matrix OLED (AMOLED), a flexible display, a bended display, and a Three-Dimensional (3D) display. Some displays among them may be implemented using a transparent display configured with a transparent or optical transmissive type to see the outside.

According to an embodiment of the present disclosure, the main display module 140 is prepared as a touch screen including a display panel and a touch panel to be used as an input device in addition to an output device. The touch panel may be configured to convert a pressure applied to a specific portion of the main display module 140 or a change in capacitance occurring at a specific portion of the main display module 140 into electrical input signals. The touch panel may be configured to detect a pressure when touched in addition to a touched position and area. The touch panel may be disposed at the display panel. The touch panel may be implemented with an add-on type in which the touch panel is disposed on the display panel, or an on-cell type or an in-cell type in which the touch panel is inserted into the display panel.

The touch panel may deliver a user input in response to a user's gesture on the main display module 140 to the main control module 160. Herein, a user input occurring by a touch means such as a finger or a touch pen may include touch, multi touch, Tap, Double Tap, Long tap, Tap & touch, Drag, Flick, Press, pinch in, and pinch out. The above-mentioned user input may be used to define communication message auto forwarding setting or release and specific application designation. For example, when a specific application is in execution, if at least one of the user inputs occurs, the main control module 160 may include an application in execution as a communication message auto forwarding setting application. Upon the receipt of a communication message during corresponding application execution, the main control module 160 may perform a control to transmit the communication message to the sub electronic device 200 automatically.

The main memory 150 may store programs or applications for processing and control of the main control module 160. The main memory 150 may temporarily store input/output data (e.g., phone numbers, messages, audio, media contents such as music files and video files, and applications). According to an embodiment of the present disclosure, the main memory 150 may include a relay processing program 151. The relay processing program 151 may include at least one routine (information relating to function execution or data storage, for example, an instruction set, a syntax or function relating to an instruction set, a class, or a template) relating to forwarding processing of a received communication message. For example, the relay processing program 151 may include a routine collecting access information on the sub electronic device 200, a routine collecting information on the other electronic device 400 transmitting an auto forwarding communication message, and a routine collecting application designation information or state designation information relating to a communication message auto forwarding setting. The relay processing program 151 may include communication message collection routines and communication message transmission routines.

The main memory 150 may include at least one type of storage medium among memories such as a flash memory type memory, a hard disk type memory, a micro type memory, a card type memory (e.g., a Secure Digital (SD) Card or an eXtreme Digital (XD) Card), a Random Access Memory (RAM), a Static RAM (SRAM), a Read-Only Memory (ROM), a Programmable ROM (PROM), an Electrically Erasable PROM (EEPROM), a magnetic memory, a magnetic disk type memory, and an optical disk type memory. The main memory 150 may operate in relation to a web storage performing a storage function of the main memory 150 on internet.

The second main communication module 170 may be a module supporting communication within a specified short range wiredly/wirelessly. A short range communication method may include Bluetooth, Bluetooth Low Energy (BLE), Radio Frequency Identification (RFID), infrared Data Association (IrDA), Ultra Wideband (UWB), ZigBee, and Near Field Communication (NFC). The second main communication module 170 may establish a short range communication channel with a short range communication module in the sub electronic device 200 and may perform communication message forwarding. When a short range communication channel established with the sub electronic device 200 is released, the second main communication module 170 may be deactivated. The second main communication module 170 may attempt a short range communication channel formation with the sub electronic device 200 in correspondence to a control of the main control module 160.

The main control module 160 may perform processing and delivery of various signals relating to a control of the main electronic device 100 and delivery and processing of data. For example, the main control module 160 may automatically forward a communication message that the other electronic device 400 transmits to the sub electronic device 200. In relation to this, the main control module 160 may include a communication message collection module 161 and a communication message transmission module 163.

When a communication message is received from the other electronic device 400 through the network 300, the communication message collection module 161 may collect the communication message. The communication message collection module 161 may determine the type of the collected communication message and may then differently apply a time for delivering a message to the communication message transmission module 163. According to an embodiment of the present disclosure, when the collected communication message is text message, multimedia message, e-mail, or chatting message, the communication message collection module 161 may deliver a communication message to the message transmission module 163 at specified time intervals. According to an embodiment of the present disclosure, the communication message collection module 161 may transmit a corresponding communication message to the communication message transmission module 163 according to the number of accumulated communication messages. Alternatively, the communication message collection module 161 may transmit a communication message to the communication message transmission module 163 in real time or at specified periods according to the information of the other electronic device 400 transmitting the communication message and the emergency designation of the transmitted communication message.

The communication message collection module 161 may control output or delivery of a communication message corresponding to a current state of the main electronic device 100. According to an embodiment of the present disclosure, when the main electronic device 100 is in a sleep mode state, the communication message collection module 161 may deliver a communication message to the communication message transmission module 163. According to an embodiment of the present disclosure, while the main electronic device 100 executes an application of a designated specific function, the communication message collection module 161 may deliver a communication message to the communication message transmission module 163.

According to various embodiments of the present disclosure, the communication message collection module 161 compares priority information of a designated application and priority information of a received communication message to determine whether to deliver a communication message. For example, when a call connection message or a text message is received during execution of a video playback application having a relatively high priority, the communication message collection module 161 may deliver this to the communication message transmission module 163. When a call connection message or a text message is received during execution of a sound playback application having a relatively low priority, the communication message collection module 161 may perform a control not to deliver the message (e.g., the call connection message or the text message) to the communication message transmission module 163 but output the message through the main display module 140 and the main audio module 130. When an emergency text message is received during execution of a video playback application, the communication message collection module 161 may perform a control to allow the main electronic device 100 to output a call connection message or a text message. The emergency text message may be index information relating to emergency written in the header information of a message. The communication message collection module 161 may determine whether a corresponding communication message is emergency or normal by examining the header information of a message. The above-mentioned priority information may be adjusted according to a user setting. Additionally, when a specific communication message (e.g., a communication message from an electronic device of a specific person, or an emergency call) is received, the communication message collection module 161 may perform a control to output the message to the main electronic device 100 and also forward the message to the sub electronic device 200.

The communication message transmission module 163 may receive a communication message from the communication message collection module 161 and may then forward the communication message to the sub electronic device 200. In relation to this, the message forwarding device 163 may determine a communication state with the sub electronic device 200. When the communication message transmission module 163 establishes a short range communication channel with the sub electronic device 200, the transmission module 163 may forward a communication message to the sub electronic device 200 through a short range communication channel. When the communication message transmission module 163 cannot establish a short range communication channel with the sub electronic device 200, the transmission module 163 may forward a communication message to the sub electronic device 200 through the network 300. During this process, the communication message transmission module 163 may deliver a communication message to the message forwarding device 500.

According to various embodiments of the present disclosure, communication message forwarding may be adjusted according to the type of a communication channel established with the sub electronic device 200. For example, the main control module 160 may transmit a communication message having a data amount of more than a specified size, for example, e-mail, multimedia message, and video call, to the sub electronic device 200 when a short range communication channel is formed. Additionally, the main control module 160 may transmit a communication message having a data amount of less than a specified size, for example, text message or chatting message, to the sub electronic device 200 through a short range communication channel or the network 300.

As mentioned above, the main electronic device 100 may include a first main communication module 110 receiving a communication message and a main control module 160 performing a control to forward the communication message to the sub electronic device 200 in correspondence to at least one of the type of the communication message, the type of an application in execution, and a sleep state.

According to various embodiments of the present disclosure, the main electronic device 100 may include a second main communication module 170 establishing a short range communication channel with the sub electronic device 200.

According to various embodiments of the present disclosure, when the short range communication channel is established currently, the main control module 160 performs a control to forward the communication message to the short range communication channel and when the short range communication channel is released, performs a control to forward the communication message based on the first main communication module 110.

According to various embodiments of the present disclosure, the main control module 160 performs a control to forward the communication message based on the second main communication module 170 in correspondence to the type of the communication message or performs a control to forward the communication message based on the first main communication module 110.

According to various embodiments of the present disclosure, the main control module 160 performs a control to forward the communication message based on the second main communication module 170 in correspondence to the type of the application or performs a control to forward the communication message based on the first main communication module 110.

According to various embodiments of the present disclosure, the main control module 160 may apply forwarding periods of the communication message differently in correspondence to the type of the communication message.

According to various embodiments of the present disclosure, the main control module 160 performs a control to output the communication message to at least one of the main display module 140 and the main audio module 130 in correspondence to at least one of the type of the communication message, the type of an application in execution, and a sleep state.

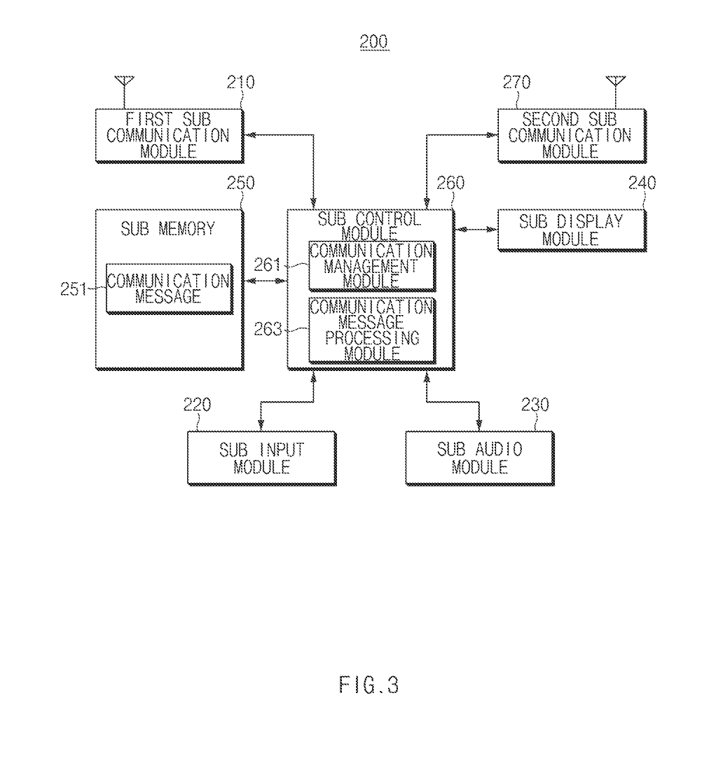

FIG. 3 is a view illustrating a sub electronic device according to an embodiment of the present disclosure.

Referring to FIG. 3, a sub electronic device 200 may include a first sub communication module 210, a sub input module 220, a sub audio module 230, a sub display module 240, a sub memory 250, a sub control module 260, and a second sub communication module 270, but is not limited thereto. The sub electronic device 200 may further include a camera module when supporting video call service.

The first sub communication module 210 may establish a communication channel with the network 300. For example, the first sub communication module 210 may be a wireless interne communication module. The first sub communication module 210 may receive a communication message forwarded from the main electronic device 100 through the network 300. The first sub communication module 210 may establish a communication channel with the message forwarding device 500 through the network 300. The first sub communication module 210 may receive a communication message forwarded by the main electronic device 100 from the message forwarding device 500. The communication message that the first sub communication module 210 receives may be outputted through the sub display module 240. The communication message that the first sub communication module 210 receives may be stored in the sub memory 250 temporarily or semi-permanently. When the second sub communication module 270 is in a deactivation state, the first sub communication module 210 may be activated automatically in correspondence to a control of the sub control module 260. According to an embodiment of the present disclosure, the first sub communication module 210 may receive a forwarded call connection request message. The first sub communication module 210 may establish a call channel with the other electronic device 400 that request a call connection in correspondence to an input event.

The sub input module 220 may generate an input signal of the sub electronic device 200. The sub input module 220 may include at least one button key (not shown). At least one button key may be disposed on at least one of the side, front, or rear of the sub electronic device 200. At least one button key may include a plurality of keys arranged in a matrix. The sub input module 220 may include at least one numeric key, character key, or navigation key. Moreover, when the sub display module 240 includes a touch sheet or a touch panel, the sub input module 220 may include the sub display module 240 as an input means.

The sub input module 220 may generate an input signal relating to the received communication message confirmation. The sub input module 220 may generate an input signal relating to the call connection release. The sub input module 220 may generate an input signal relating to the received communication message deletion. When the communication message is a call connection request message, the sub input module 220 may generate an input signal relating to the call connection rejection. An input signal generated by the sub input module 220 may be delivered to the sub control module 260 to be used as a command or command set relating to a corresponding function execution.

The sub audio module 230 may support audio signal processing of the sub electronic device 200. For example, when audio data is included in the received communication message, the sub audio module 230 may output corresponding audio data. When a call channel is established, the sub audio module 230 activates a microphone and delivers collected audio data to the first sub communication module 210. The sub audio module 230 may output guiding sounds or sound effects relating to a short communication channel establishment or a short range communication channel release. The sub audio module 230 may output guiding sounds or sound effects relating to a communication channel establishment or release based on the first sub communication module 210. The sub audio module 230 may provide guiding sounds, sound effects, or vibration outputs relating to the communication message reception. The above-mentioned guiding sounds, sound effects, or vibration outputs may be omitted in correspondence to a user setting.

The sub display module 240 may output various screens relating to the management of the sub electronic device 200. According to an embodiment of the present disclosure, the sub display module 240 may output a standby screen including time information and weather information. According to an embodiment of the present disclosure, the sub display module 240 may output a screen relating to the forwarded communication message reception. For example, the sub display module 240 may output a text message reception screen, a multimedia message reception screen, an e-mail reception screen, and a call connection request message reception screen.

The sub display module 240 may output information on the current communication state. For example, the sub display module 240 may output information on whether the current short range communication channel is established or whether a communication channel based on the network 300 is established. When a short range communication channel with the main electronic device 100 is released, the sub display module 240 may output alarm information associated with a release. Additionally, when the first sub communication module 210 is activated, the sub display module 240 may output alarm information associated with a release.

The sub display module 240 may output information on a communication connection state relating to a plurality of electronic devices 101, 102, and 103. The sub display module 240 may classify and display communication messages received from the plurality of electronic devices 101, 102, and 103 by each electronic device. During this process, the sub display module 240 may output the received communication message as in a list. When a specific item is selected from the list, the sub display module 240 may output detailed information on the selected item, for example, communication message content information, communication message reception time information, and communication message processing information.

The sub memory 250 may store applications, programs, and data relating to the management of the sub electronic device 200. For example, the sub memory 250 may store operating system and communication message processing program supporting the management of the sub electronic device 200. The communication message processing program may include a routine supporting received communication message output, a routine performing processing relating to a call channel establishment during the received communication message, and a routine supporting communication message deletion. The sub memory 250 may store a communication message 251. The communication message 251 may include at least one of a text message, an e-mail, a multimedia message, a chatting message, and a voice message. The communication message 251 may be deleted in correspondence to a control of the sub input module 220. Alternatively, the communication message 251 may be forwarded again to the main electronic device 100 in correspondence to a control of the sub input module 220.

The second sub communication module 270 may establish a communication channel with the second main communication module 170 of the main electronic device 100. The second sub communication module 270 may be configured using a communication module compatible with or identical to the second main communication module 170. In correspondence to a setting, the second sub communication module 270 may have a standby state relating to a short range communication channel establishment. Alternatively, in correspondence to a setting, the second sub communication module 270 may scan the second main communication module 170 to establish a short range communication channel. The second sub communication module 270 may release a short range communication channel when the sub electronic device 200 is spaced more than a communication coverage distance from the main electronic device 100. When a short range communication channel is released, the second sub communication module 270 may deliver this to the sub control module 260.

The sub control module 260 may perform various signal flow controls and signal processing relating to a control of the sub electronic device 200 and data transmission processing. According to an embodiment of the present disclosure, the sub control module 260 may include a communication management module 261 and a communication message processing module 263.

The communication management module 261 may control communication channel establishment and release. According to an embodiment of the present disclosure, the communication management module 261 may establish a short range communication channel with the main electronic device 100. During this process, if there is no main electronic device 100 for establishing a short range communication channel, the communication management module 261 may deactivate the second sub communication module 270. When the second sub communication module 270 is in a deactivation state, the communication management module 261 may activate the first sub communication module 210. The communication management module 261 may activate the second sub communication module 270 in a deactivation state and may scan the main electronic device 100 in correspondence to an input event of the sub input module 220 or a set schedule event. When a short range communication channel with the main electronic device 100 is established, the communication management module 261 may perform a control to deactivate the network communication channel based on the first sub communication module 210.

According to various embodiments of the present disclosure, the communication management module 261 may perform a control to substantially simultaneously activate the first sub communication module 210 and the second sub communication module 270. The communication management module 261 may receive a communication message from the first electronic device 101 and the second electronic device 102 by using the network communication channel based on the first sub communication module 210. Then, the communication management module 261 may receive a communication message from the third electronic device 103 by using the network communication channel based on the second sub communication module 270. According to various embodiments of the present disclosure, when the communication management module 261 cannot establish a short range communication channel with the electronic devices 101, 102, and 103, the communication management module 261 may perform a control to receive a communication message that the electronic devices 101, 102, and 103 forward through the first sub communication module 210.

The communication message processing module 263 may process output and storage of the received communication message 251. Upon the receipt of a text or image related message such as text message or e-mail, the communication message processing module 263 may perform a control to output a reception alarm through at least one of the sub display module 240 and the sub audio module 230. The communication message processing module 263 may store the received text or image related message temporarily or semi-permanently. Upon the receipt of a call channel related message, the communication message processing module 263 may perform a control to output the message through at least one of the sub display module 240 and the sub audio module 230.

The communication message processing module 263 may establish a call channel or perform a call connection rejection in correspondence to an input event inputted from the sub display module 240 or the sub input module 220. For example, when an input event relating to a call channel establishment occurs, the communication message processing module 263 may establish a call channel with the other electronic device 400. When an input event relating to a call connection rejection occurs, the communication message processing module 263 may deliver a call connection rejection message to the network 300. The network 300 may transmit a call connection rejection message to the other electronic device 400.

According to various embodiments of the present disclosure, when a call channel connection is required during a process for processing a communication message received through a short range communication channel, the communication message processing module 263 may perform a control to activate the first sub communication module 210. When a call channel connection is required during a process for processing a communication message received through the first sub communication module 210, the communication message processing module 263 may process a call connection by using the first sub communication module 210.

According to various embodiments of the present disclosure, when a communication message forwarding event occurs, the communication message processing module 263 may forward a communication message to an electronic device that forwards the communication message before. For example, when the first electronic device 101 forwards a specific communication message, the communication message processing module 263 may forward a corresponding communication message to the first electronic device 101 again.

Moreover, the above-mentioned embodiments of the present disclosure may be implemented in a program command format executed by various computer means and then recorded on a computer readable recording medium. The computer readable recording medium may include a program command, a data file, and a data structure alone or in combination thereof. The program command recorded on the recording medium may be specifically designed or configured for various embodiments of the present disclosure or may be known to those skilled in the art.

The above embodiments of the present disclosure may be realized in a recording medium readable by a computer or a device similar thereto by using by using software, hardware, or a combination thereof. According to hardware implementation, various embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units performing other functions. In some cases, the various embodiments of the present disclosure may be implemented using the main control module 160 and the sub control module 260. According to software implementation, the various embodiments of the present disclosure relating to a procedure and function may be implemented using additional software modules. Each of the software modules may perform at least one function and operation described in this specification.

As mentioned above, the sub electronic device 200 may include a first sub communication module 210 receiving a forwarded communication message through a network communication channel, a second sub communication module 270 receiving the forwarded communication message thorough a short range communication channel, a sub control module 260 controlling the communication message reception through at least one of the first sub communication module 210 and the second sub communication module 270, and a sub display module 240 outputting the received communication message.

According to various embodiments of the present disclosure, the sub display module 240 may classify communication messages forwarded from a plurality of electronic devices by each device and may then output them.

According to various embodiments of the present disclosure, the sub display module 240 may output communication channel type information of communication messages forwarded from a plurality of electronic devices.

According to various embodiments of the present disclosure, the sub display module 240 may output type information of applications being executed by a plurality of electronic devices that forward the communication message.

According to various embodiments of the present disclosure, the sub control module 260 may perform a control to provide a call connection with the other electronic device 400 or transmit a call rejection message in correspondence to an input event for call connection or rejection of a communication message relating to a call connection request.

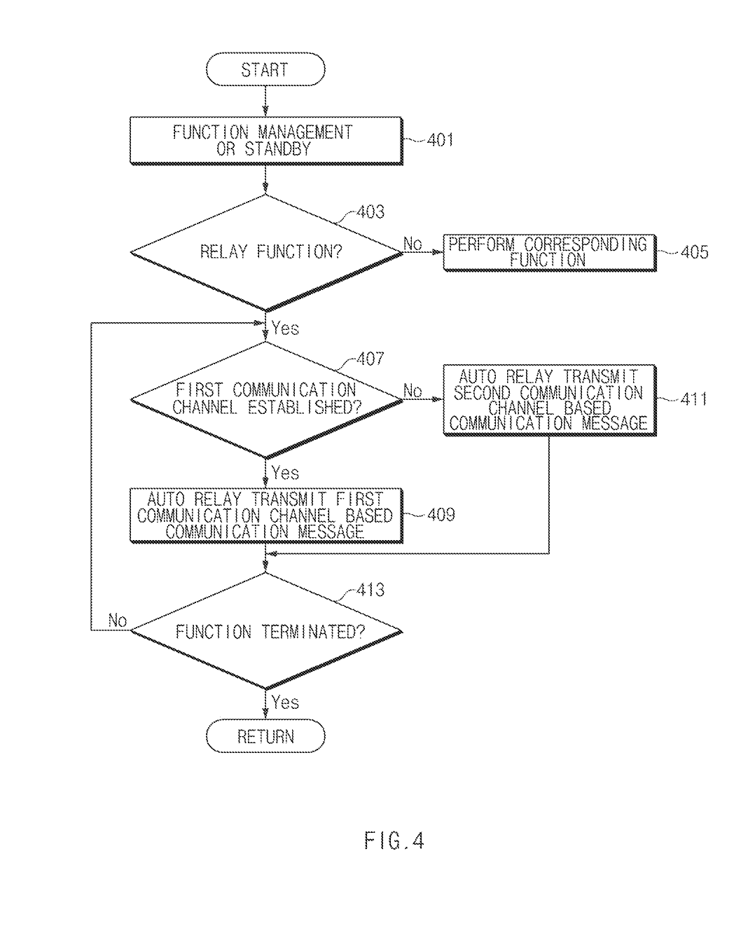

FIG. 4 is a view illustrating a management method of a main electronic device relating to a communication message management according to an embodiment of the present disclosure.

Referring to FIG. 4, the main control module 160 of the main electronic device 100 may perform function management or standby in operation 401. The main electronic device 100 may have a sleep state, a specific function management state, and/or a standby state.

In operation 403, the main control module 160 may determine whether there is a relay function setting or a relay function execution related event. For example, the main control module 160 may determine whether there is a communication message reception from the other electronic device 400 in relation to a relay function. When there is no relay function setting in operation 403, the main control module 160 branches to operation 405 to maintain a previous function execution or control a specific function execution corresponding to an occurring event. For example, the main control module 160 may maintain the sleep state or may maintain a specific function in execution previously, for example, a music playback function or a video playback function.

When there is a relay function setting or an event relating to a relay function execution occurs in operation 403, the main control module 160 may determine whether there is a first communication channel establishment in operation 407. The first communication channel may be a communication channel established based on the second main communication module 170. For example, the first communication channel may be a short range communication channel. When the first communication channel is established at operation 407, the main control module 160 may perform first communication channel based communication message auto relay transmission in operation 409.

When the first communication channel is not established in operation 407, the main control module 160 may perform second communication channel based communication message relay transmission in operation 411. The main control module 160 may establish a network communication channel by using address information for establishing a network communication channel with the sub electronic device 200. Herein, address information may be the phone number of the sub electronic device 200. Additionally, address information may be the IP address information of the sub electronic device 200. During one of operation 409 and operation 411, the main control module 160 may apply an auto relay period differently in correspondence to the type of a communication message. For example, in the case of a text or image related message, the main control module 160 may forward the message to the sub electronic device 200 at specified time intervals. In the case of a call connection related message, the main control module 160 may forward the message to the sub electronic device 200 in real time.

In operation 413, the main control module 160 may determine whether a function termination related event occurs. When the function termination related event occurs, the main control module 160 may branch to an operation prior to operation 401 and may then perform subsequent operations again. If there is no function termination related event, the main control module 160 branches to an operation prior to operation 407 to relay a received communication message through at least one of the first communication channel and the second communication channel.

According to various embodiments of the present disclosure, operation 407 may be replaced by an operation for determining the type of an application in execution currently. Accordingly, when a predefined specific type of application is in execution, the main control module 160 may perform a communication message relay by using the first communication channel or the second communication channel. For example, when the second communication channel (e.g., a network communication channel) is managed as a video call function is executed, on the receipt of a communication message from the other electronic device 400, the main control module 160 may forward the message to the sub electronic device 200 through the first communication channel (e.g., a short range communication channel). Additionally, when a streaming service is managed based on the first communication channel, the main control module 160 may transmit a communication message received from the other electronic device 400 to the sub electronic device 200 through the second communication channel.

According to various embodiments of the present disclosure, operation 407 may be replaced by an operation for determining the type of a received communication message. When a received communication message is a message including text or a message requiring a call connection, the main control module 160 may relay the message through the second communication channel. When a received communication message is a message including an image having a data amount of more than a specified size, the main control module 160 may relay the message through the first communication channel.

According to various embodiments of the present disclosure, the main control module 160 may determine whether to execute an auto relay function of a communication message in correspondence to the type of an application in execution currently. For example, during a standby screen output state or when a gallery function is executed currently, without relaying a received communication message, the main control module 160 may perform a control to output the message. During a standby screen output state or when a streaming service function is executed currently, the main control module 160 may perform a control to automatically relay the received communication message. During the auto relay process, the main control module 160, as mentioned above, may forward the message to the sub electronic device 200 by using at least one of the first communication channel and the second communication channel.

According to various embodiments of the present disclosure, the main control module 160 may determine whether to execute an auto relay function according to a state of the current main electronic device 100. For example, when the current main electronic device 100 is in a sleep state, the main control module 160 may perform a control to execute a communication message auto relay function. During the auto relay process, the main control module 160 may forward a communication message by using at least one of the first communication channel and the second communication channel. For example, when the main display module 140 of the current main electronic device 100 is in a turn-on state, the main control module 160 may perform a control to output a communication message to the main display module 140.

As mentioned above, a communication message management method according to an embodiment of the present disclosure may receive, by at least one main electronic device 100, a communication message from the other electronic device 400 and forwarding the communication message to the sub electronic device 200 in correspondence to at least one of the type of the communication message, the type of an application in execution, and a sleep state.

According to various embodiments of the present disclosure, the forwarding of the communication message may include, when the current short range communication channel with the sub electronic device 200 is established, forwarding the communication message to the sub electronic device 200 through the short range communication channel and when the current short range communication channel with the sub electronic device 200 is released, forwarding the communication message to the sub electronic device 200 based on a network communication channel.

According to various embodiments of the present disclosure, the forwarding of the communication message may include forwarding the communication message to the sub electronic device 200 through a short range communication channel in correspondence to at last one of the type of the communication message and the type of the application or forwarding the communication message to the sub electronic device 200 through a network communication channel.

According to various embodiments of the present disclosure, the forwarding of the communication message may include applying forwarding periods of the communication message differently in correspondence to the type of the communication message.

According to various embodiments of the present disclosure, the method may further include outputting the communication message to at least one of the main display module 140 and the main audio module 130 in correspondence to at least one of the type of the communication message, the type of an application in execution, and a sleep state.

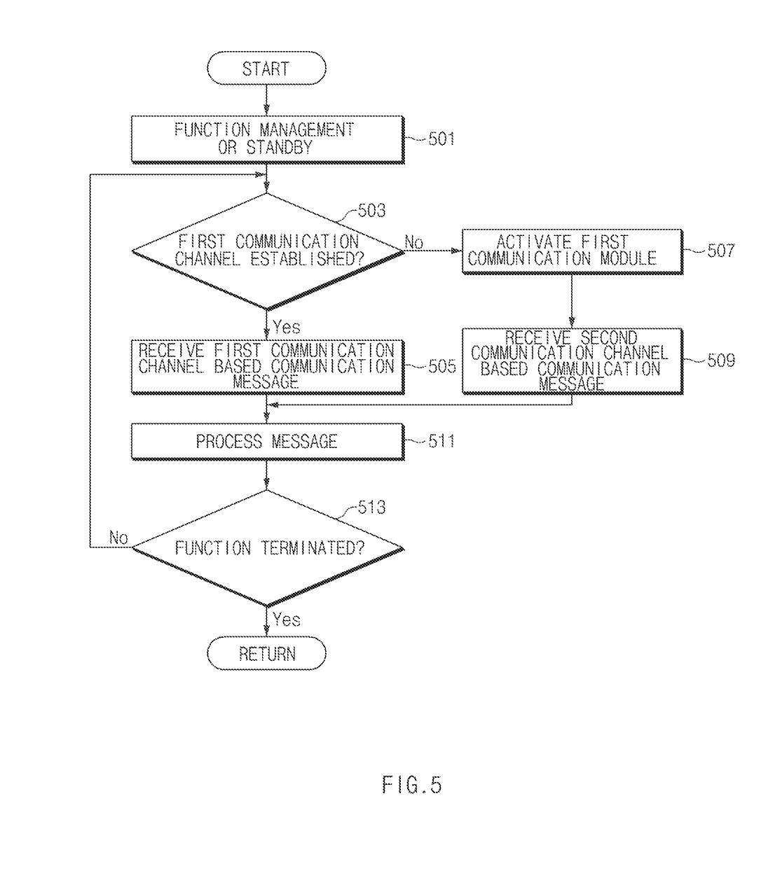

FIG. 5 is a view illustrating a management method of a sub electronic device relating to a communication message management according to an embodiment of the present disclosure.

Referring to FIG. 5, the sub control module 260 of the sub electronic device 200 may perform function management or standby in operation 501. For example, the sub control module 260 may perform a control to execute a watch function. Alternatively, the sub control module 260 may support a sleep mode state (that is, the sub display module 240 is turned-off).

In operation 503, the sub control module 260 may determine whether a first communication channel (e.g., a short range communication channel) is established. When the first communication channel is established, the sub control module 260 may perform a first communication channel based communication message reception in operation 505.

When the first communication channel is not established in operation 503, the sub control module 260 may activate the first sub communication module 210 in operation 507. The sub control module 260 may perform a communication message reception based on a second communication channel (e.g., a network communication channel) established based on the first sub communication module 210.

The sub control module 260 may process the received communication message in operation 511. For example, the sub control module 260 may output the received communication message to at least one of the sub display module 240 and the sub audio module 230. According to an embodiment of the present disclosure, upon the receipt of a text or image related communication message, the sub control module 260 may output a communication message reception alarm to the sub display module 240. The sub control module 260 may output a message content when an input event relating to the corresponding message confirmation occurs. The sub control module 260 may store the received communication message in the sub memory 250 automatically. The sub control module 260 may delete the received communication message in correspondence to an input event. According to an embodiment of the present disclosure, upon the receipt of a call related message, the sub control module 260 may output a call related message reception alarm to the sub display module 240.

When an input event relating to a call related message processing occurs, the sub control module 260 may perform call related processing according thereto. For example, when an input event relating to a call connection occurs, the sub control module 260 may establish a call channel with the other electronic device 400. When an input event relating to a call connection rejection occurs, the sub control module 260 may transmit a call connection rejection message to the other electronic device 400 or a server device supporting a communication channel with the other electronic device 400. According to various embodiments of the present disclosure, when a communication message forwarding related event occurs, the sub control module 260 may forward a corresponding communication message again to an electronic device that forwarded a communication message before.

In operation 513, the sub control module 260 may determine whether a function termination related event occurs. When the function termination related event occurs, the sub control module 260 may terminate a communication message processing function. For example, the sub control module 260 may perform a control to deactivate the first sub communication module 210. When the function termination related event does not occur, the sub control module 260 may branch to an operation before operation 501 and may then perform subsequent operations again.

According to various embodiments of the present disclosure, the sub control module 260 may establish at least one communication channel of the first communication channel and the second communication channel with at least one electronic device among a plurality of electronic devices. For example, the sub control module 260 may establish a first communication channel with the first electronic device 101. The sub control module 260 may receive a communication message forwarded from the first electronic device 101 through the first communication channel. The sub control module 260 may communicate with the second electronic device 102 and the third electronic device 103 through the second communication channel. The sub control module 260 may receive a communication forwarded by the second electronic device 102 and the third electronic device 103 through the second communication channel. In relation to this, the sub control module 260 may activate at last one of the first sub communication module 210 and the second sub communication module 270.

According to various embodiments of the present disclosure, when a first communication channel established with the first electronic device 101 and then released, the sub control module 260 may establish the first communication channel with the second electronic device 102 or the third electronic device 103. The sub control module 260 may receive a communication message from the first electronic device 101 based on the second communication channel. According to an embodiment of the present disclosure, when the first communication channel cannot be established with electronic devices 101, 102, and 103, for example, when the sub electronic device 200 is spaced more than a communication coverage distance from the electronic devices 101, 102, and 103, the sub control module 260 may receive a communication message forwarded from the electronic devices 101, 102, and 103 through the second communication channel.

As mentioned above, a communication message management method according to an embodiment of the present disclosure may include receiving, by the sub electronic device 200, a communication message forwarded by at least one main electronic device 100 and classifying and outputting, by the sub electronic device 200, the forwarded communication message for each main electronic device.

According to various embodiments of the present disclosure, the outputting of the communication message may include at least one of outputting communication channel type information of a communication message for each main electronic device and outputting, by a plurality of electronic devices forwarding the communication message, type information of an application in execution currently.

According to various embodiments of the present disclosure, the method may further include receiving an input event for a call connection or rejection of a communication message relating to a call connection request and performing a call connection with the other electronic device 400 that transmits the communication message to the main electronic device 100 or transmitting a call rejection message to the other electronic device 400.

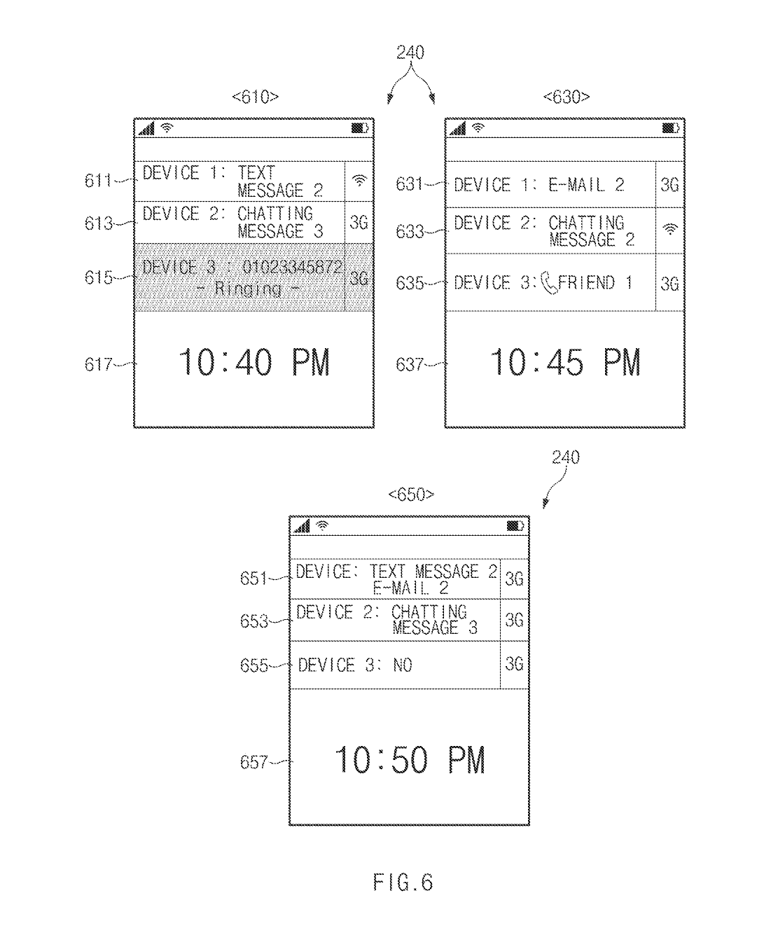

FIG. 6 is a view illustrating a screen interface of a sub electronic device relating to a communication message reception according to an embodiment of the present disclosure.

Referring to FIG. 6, the sub electronic device 200 may establish a communication channel with the plurality of electronic devices 101, 102, and 103. During this process, the sub electronic device 200 may establish another communication channel with the plurality of electronic devices 101, 102, and 103. For example, the sub electronic device 200 may establish a short range communication channel with the electronic device 101. The sub electronic device 200 may establish a network communication channel with the second electronic device 102 and the third electronic device 103. As shown in a screen 610, the sub display module 240 may distinguish and display information corresponding to a communication channel type connected each of the electronic devices 101, 102, and 103 and a communication message provided from each of the electronic devices 101, 102, and 103. For example, the sub display module 240 may output a screen including a communication message 611 received from the first electronic device 101, a communication message 613 received from the second electronic device 102, and a communication message 615 received from the third electronic device 103. According to various embodiments of the present disclosure, the sub display module 240 may output first time information 617 according to a specific function, for example, a watch function.

The communication message 611 may include a text message as a message forwarded by the first electronic device 101. The communication message 613 may include a chatting message as a message forwarded by the second electronic device 102. The communication message 615 may include a call connection message as a message forwarded by the third electronic device 103. The message 615 may be a message requesting connection in real time. Accordingly, the communication message 615 may provide display effects relating to a call connection, for example, flashing effects.

According to various embodiments of the present disclosure, the sub electronic device 200 may establish a network communication channel with the first electronic device 101. The sub electronic device 200 may establish a short range wireless communication channel with the second electronic device 102. The sub electronic device 200 may establish a network communication channel with the third electronic device 103. As shown in a screen 630, the sub display module 240 may include a communication message 631 including an e-mail message, a communication message 633 including a chatting message, and a communication message 635 including a call connection request related message. The sub display module 240 may output second time information 637.

According to various embodiments of the present disclosure, the sub electronic device 200 may establish a network communication channel with the first electronic device 101, the second electronic device 102, and the third electronic device 103. As shown in a screen 650, the sub display module 240 may include a communication message 651 including a text message and an e-mail message, a communication message 653 including a chatting message, and a communication message 655 having no additional message reception state. The sub display module 240 may output third time information 657.

Moreover, although it is described in the above that the sub display module 240 outputs communication messages and communication channel information received from the three electronic devices 101, 102, and 103, various other embodiments are not limited thereto. For example, the sub display module 240 may output only communication message items relating to electronic devices establishing the current communication channel. Alternatively, the sub display module 240 may output only communication message items relating to electronic devices establishing a specific communication channel (e.g., the first communication channel or the second communication channel).

According to various embodiments of the present disclosure, the sub display module 240 may output type information of applications being currently executed by the electronic devices 101, 102, and 103 that forward a communication message or the current state information of the electronic devices 101, 102, and 103. For example, when the first electronic device 101 performs a video playback function, the sub display module 240 may output an image or text indicating the video playback function to the communication messages 611, 631, and 651 relating to the first electronic device 101. When the third electronic device 103 performs a video call function, the sub display module 240 may output an image or text indicating the video call function to the communication messages 613, 633, and 653 relating to the third electronic device 103.

As mentioned above, a communication message management method and an electronic device supporting the same according to an embodiment of the present disclosure may perform communication message confirmation more adaptively by forwarding a communication message transmitted from another electronic device to a companion electronic device or a sub electronic device. Additionally, according to an embodiment of the present disclosure, since a sub electronic device obtains and provides a communication message that a plurality of electronic devices receive through at last one communication, the communication message reception managements of electronic devices may be processed integrally and clearly.

Moreover, with the convergence trend of digital devices, their modifications are very diverse but all cannot be listed. However, the main electronic device 100 and the sub electronic device 200 may further include components not mentioned above, for example, an acceleration sensor, a gyro sensor, a Global Positioning System (GPS) module, an NFC module, a vibration motor, and an accessory. Additionally, according to the provided forms the main electronic device 100 and the sub electronic device 200, a specific component may be excluded from the above components or may be replaced by another component.

As mentioned above, according to a communication message management method and an electronic device supporting the same suggested by various embodiments of the present disclosure, a communication message may be determined and processed in real time by adaptively selecting a communication available module.

Additionally, according to various embodiments of the present disclosure, since a specific electronic device collects a communication message for each electronic device and notifies this, communication message reception confirmation and management may be processed easily.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A main electronic device comprising:
a first main communication module configured to receive a communication message; and
a main control module configured to forward the communication message to a sub electronic device in correspondence to at least one of a type of the communication message, a type of an application in execution, and a sleep state.

2. The main electronic device of claim 1, further comprising a second main communication module configured to establish a short range communication channel with the sub electronic device.

3. The main electronic device of claim 2,
wherein, when the short range communication channel is established, the main control module is further configured to forward the communication message through the short range communication channel, and
wherein, when the short range communication channel is released, the main control module is further configured to forward the communication message based on the first main communication module.

4. The main electronic device of claim 2, wherein the main control module is further configured:
to forward the communication message based on the second main communication module in correspondence to the type of the communication message; or
to forward the communication message based on the first main communication module.

5. The main electronic device of claim 2, wherein the main control module is further configured:
to forward the communication message based on the second main communication module in correspondence to the type of the application; or
to forward the communication message based on the first main communication module.

6. The main electronic device of claim 1, wherein the main control module is further configured to apply a forwarding period of the communication message differently in correspondence to the type of the communication message.

7. The main electronic device of claim 1, wherein the main control module is further configured to output the communication message to at least one of a main display module and a main audio module in correspondence to at least one of the type of the communication message, the type of an application in execution, and the sleep state.

8. A sub electronic device comprising:
a first sub communication module configured to receive a forwarded communication message through a network communication channel or a second sub communication module configured to receive the forwarded communication message through a short range communication channel;
a sub control module configured to control the communication message reception through at least one of the first sub communication module and the second sub communication module; and
a sub display module configured to output the received communication message.

9. The sub electronic device of claim 8, wherein the sub display module is further configured to classify and to output communication messages forwarded by a plurality of electronic devices by each device.

10. The sub electronic device of claim 8, wherein the sub display module is further configured to output communication channel type information of a communication message forwarded by at least one of a plurality of electronic devices.

11. The sub electronic device of claim 8, wherein the sub display module is further configured to output type information of an application executed currently by at least one of a plurality of electronic device forwarding the communication message.

12. The sub electronic device of claim 8, wherein the sub control module is further configured:
to perform a call connection with another electronic device; or
to forward a call rejection message in correspondence to an input event for a call connection or rejection of a communication message relating to a call connection request.

13. A communication message management method comprising:
receiving, by at least one main electronic device, a communication message from another electronic device; and
forwarding, by the at least one main electronic device, the communication message to a sub electronic device in correspondence to at least one of a type of the communication message, a type of an application in execution, and a sleep state.

14. The method of claim 13, wherein the transmitting of the communication message comprises one of:
transmitting the communication message to the sub electronic device through the short range communication channel when the short range communication channel is established with the sub electronic device;
transmitting the communication message to the sub electronic device based on a network communication channel when the short range communication channel with the sub electronic device is released;
transmitting the communication message to the sub electronic device through a short range communication channel in correspondence to at least one of the type of the communication message and the type of the application; or
transmitting the communication message to the sub electronic device through a network communication channel.

15. The method of claim 13, wherein the transmitting of the communication message comprises applying a transmitting period of the communication message differently in correspondence to the type of the communication message.

16. The method of claim 13, further comprising outputting the communication message to at least one of a main display module and a main audio module in correspondence to at least one of the type of the communication message, the type of an application in execution, and the sleep state.

17. The method of claim 13, further comprising:
receiving, by a sub electronic device, the transmitted communication message; and
classifying and outputting, by the sub electronic device, the transmitted communication message for each of the at least one main electronic device.

18. The method of claim 17, wherein the outputting of the transmitted communication message comprises:
outputting communication channel type information of the communication message for the each of the at least one main electronic device; and
outputting, by a plurality of electronic devices that transmit the communication message, type information of the application in execution.

19. The method of claim 17, further comprising:
receiving an input event for a call connection or rejection of a communication message relating to a call connection request; and
performing a call connection with the other electronic device that transmits the communication message to the at least one main electronic device or transmitting a call rejection message to the other electronic device according to the received input event.

20. The method of claim 13, wherein, when the at least one of a type of the communication message is a video playback function, the at least one main electronic device outputs an image or text indicating the video playback function relating to the other electronic device.
